(19) United States
(12) Patent Application Publication
(10) Pub. No.: US 2015/0381416 A1
(43) Pub. Date: Dec. 31, 2015

(54) METHOD FOR AUTOMATIC PROVISIONING OF DEVICES

(71) Applicants: Lars RAMFELT, (US); Stefan GEN, (US); Fredrik LJUNGBERG, (US)

(72) Inventors: Lars RAMFELT, Sigtuna (SE); Stefan SANDHAGEN, Bromma (SE); Fredrik LJUNGBERG, Bromma (SE)

(21) Appl. No.: 14/766,325

(22) PCT Filed: Feb. 7, 2014
(86) PCT No.: PCT/US2014/015258

§ 371 Date: Aug. 6, 2015

Related U.S. Application Data
(60) Provisional application No. 61/764,151, filed on Feb. 13, 2013.

(51) Int. Cl. H04L 12/24; H04W 76/02; H04W 8/00; H04L 29/08; H04W 4/00

(52) U.S. Cl. CPC H04L 41/0806; H04L 41/0886; H04L 67/34; H04W 4/001; H04W 8/005; H04W 76/021

(57) ABSTRACT

The method is for automatic provisioning of a device. The system has a device, a hub, a server and a communication device. A communication is established between the device and the hub. The hub characterizes the device as being unmanaged.

The hub sends a notification signal to the communication device of an administrator to notify the administrator (56) about the device being characterized as unmanaged. The administrator sends an accept signal to the hub to accept the device. The hub sends a provisioning signal to the device to provision the device and characterizing the device as being managed. The hub delays sending the provisioning signal to the device as long as no accept signal is received from the administrator.

### TECHNICAL FIELD

The invention relates to a method for automatic provisioning of devices such as sensors and other electrical/electronic devices.

### BACKGROUND AND SUMMARY OF THE INVENTION

It is becoming more common to use electrical/electronic devices in everyday life such as for monitoring events. The provisioning of such ordinary devices is often governed by specific requirements developed by the device manufacturer so that the provisioning steps are different for each device. For example, some ordinary devices require the user to log into a system with a keyboard or by activating a display in order to set up or configure the device. It may also be necessary to provide the correct encryption keys to gain access to the wireless network of the dwelling. In other words, some conventional devices cannot gain access to the network without the user first providing the correct encryption keys. In other conventional devices, the user is required to push in and hold certain switches or buttons on the device while activating the firewall or hub of the network in order to permit the proper synchronization between the device and the hub. This process is often cumbersome. One major problem is that each device often requires its own unique setup procedure. For example, a certain camera manufacturer may have a set-up procedure that is very different from other camera manufacturers. Different types of devices, such as sensors and cameras, each require its own customized set-up procedure in order to connect the device to the network of the dwelling. The many different set-up procedures make it quite cumbersome for the user since most provisioning procedures operate in a direction from the devices into the network but not from the network to each device. There is a need for an effective and easy way of provisioning a wide range of devices without requiring much input from the user.

The method of the present invention provides a solution to the above-outlined problems. One important object of the present invention is to provide a very user-friendly and automatic system in which the user may simply un-pack the device, such as a sensor, and put in the batteries or turn it on to automatically start a series of provisioning steps between the device and the network of the dwelling in which the device is located. The device may also be automatically accessed from a communication device, such as a mobile telephone, anywhere in the world without the need for complicated encryption in the provisioning stages. More particularly, the method of the present invention is for automatic provisioning of a device. The system of the present invention preferably includes the device, a hub, a server and a communication device such as a mobile telephone. A communication is established between the device and the hub. The initiation of this communication may be started by the device or the hub. Upon contact, the hub initially characterizes the device as being unmanaged. The hub sends a notification signal to the communication device of an administrator to notify the administrator about the newly discovered device being characterized as unmanaged. The sending of the notification signal may be in response to a request from the communication device of the administrator. Upon receipt of the notification signal, the administrator must either accept or deny acceptance of the new device. The administrator may accept the device by sending an accept signal to the hub to accept the device. Upon receipt of the accept-signal, the hub sends a provisioning signal to the device to provision the device and characterizing the device as being managed. The hub delays sending the provisioning signal to the device as long as no accept signal is received from the administrator.

The method of the present invention further comprises the steps of the device sending an announcement signal to the hub.

The method of further comprises the steps of the hub sending a discovery request into the system to discover unmanaged devices.

The method further comprises the steps of including a unique address ID of the device in the announcement signal.

The method further comprises the steps of the hub sending configuration parameters to the device based on introspection or database lookup.

The method further comprises the steps of the device automatically sending an announcement signal at a first frequency. The device waits for a response a first time period. When no response is received within the first time period, the device sends the announcement signal at a second frequency that is different from the first frequency.

The method further comprises the steps of the hub receiving the announcement signal and registering the device on a list of unmanaged devices.

The method further comprises the steps of the administrator sending a request signal to the hub to view the list of unmanaged devices.

The method further comprises the steps of including a hub ID in the provisioning signal.

Finally, the method further comprises the steps of the hub sending a request signal to the server to request the server to identify the device based on the ID and the announcement signal.

### BRIEF DESCRIPTION OF DRAWINGS

FIG. 1 is a schematic view of the components of the system of the present invention;

FIG. 2 is a schematic view of requirements of the devices of the present invention;

FIG. 3 is a schematic view of signals sent between the components of the system of the present invention; and

FIG. 4 is a front view of a communication device connected to the system of the present invention.

### DETAILED DESCRIPTION

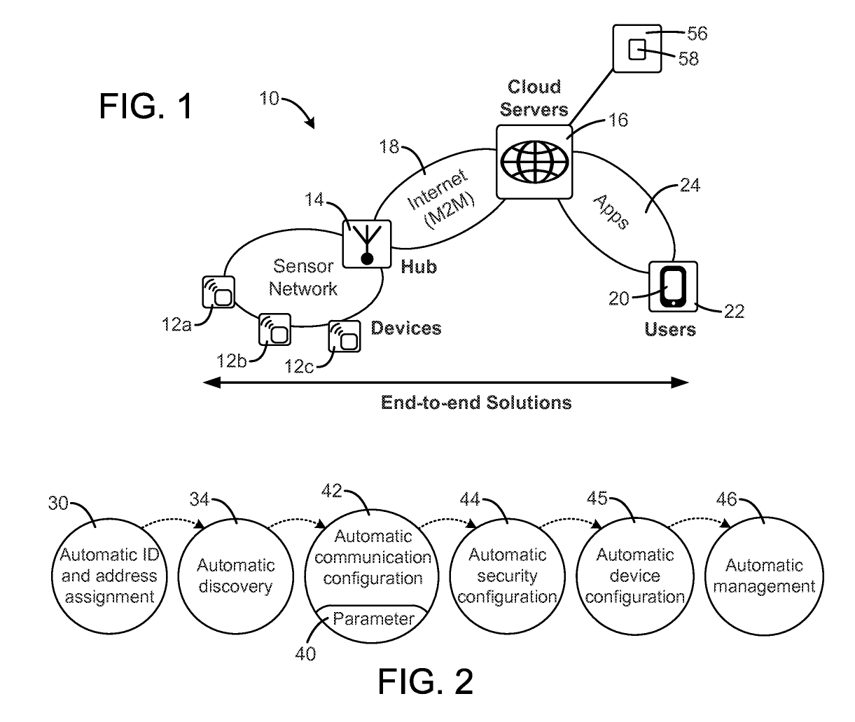

FIG. 1 is a schematic view of the system 10 of the present invention. The initial provisioning procedure of a new device may be done without the need for encryption and once the device is properly identified, encryption keys may be sent to the device from the system 10 without the need for the user to enter such encryption keys into the device. More particularly, the system 10 may have devices 12a, 12b, 12c that eventually will be in communication with a hub 14 that, in turn, is in communication with a server 16 via an Internet connection network 18 or any other suitable wired or wireless connection. The device 12 may be interpreted to represent one or many of the devices 12a-c. The devices 12a-c may be any type of electrical/electronic devices such as cameras, sensors and any other device that is to be provisioned. Preferably, the devices 12a-c must be able to communicate with the hub 14. For example, the devices 12a-c may be connected using IP (Internet Protocol) which may run over wired technologies (such as Ethernet) or wireless technologies (such as IEEE 802.15. IEEE 802.11 or ZigBee). The hub 14 may be an aggregation unit for one or many devices 12a-c. One important feature of the present invention is that devices that are to be managed by the hub 14 are automatically provisioned to the same location as the hub 14. The hub 14 preferably enables the devices 12a-c to communicate with the server 16. The hub 14 may also support advanced local user-interfaces. Preferably, the hub 14 is provisioned by the server 16. It is to be understood that the hub 14 may be a separate physical unit or a logical unit that is integrated with one or many of the devices 12a-c or other components of the system 10.

The server 16 is in communication with a communication device or terminal 20 of a user 22 that operates the terminal 20 to access the system 10. The server 16 may be a cloud server accessible via the Internet 18 that connects to the terminal 20 and hub 14. The server 16 may be used for authentication, peering, security, backup, simplicity and other similar functions. The server 16 may be one unit or a plurality of physical units that are geographically spread out anywhere in the world as long as they are accessible via a network such as the Internet 18. The communication device 20 may be any type of web-enabled gadget, such as a mobile telephone, tablet, computer or any other device that may be used to communicate with the server 16 by a wired or wireless connection. For example, the communication between the server 16 and the communication device 20 may be via a communication channel 24 such as the Internet, telephone network or any other suitable communication system. One important function of the hub 14 is to receive and transmit information between the device 12 and the server 16 and between the device 12 and the communication device 20 of the user and communication device of the administrator.

The devices 12a-c are to be provisioned. Provisioning preferably includes steps from unpacking a new device until the device is fully operational and accessible by the hub 14 and the communication device 20 of the user 22. Another important feature of the present invention is that the devices 12a-c are automatically provisioned by the hub 14. The devices 12a-c are either in a state of being managed already by the hub 14, managed by someone else, or un-managed. An unmanaged device may be characterized as a device that has been discovered by the hub 14 or the device has sent in an announcement signal into the system 10 that was received by the hub 14 but the device 12 is not yet managed by any hub, as explained in more detail below. In other words, until the newly discovered device 12 has been properly provisioned, the hub 14 characterized the device 12 as being unmanaged.

Preferably, the system 10 has an administrator 56 who has a communication device or a terminal 58 that may set up the system 10 and gain access to the devices 12a-c, the hub 14 and server 16 on any terminal connected to the Internet anywhere in the world. The administrator 56 and communication device or terminal 58 are shown as being separate from the user 22 and the communication device 20 but the administrator 56 and the user 22 could be the same person and the communication device 20 and the terminal 58 could be the same device or unit.

Each device 12 should have certain characteristics so that it can be automatically provisioned according to the method of the present invention. The devices 12a-c preferably must be able to know their unique address 28a, 28b, 28c as shown in automatic ID and address assignment characteristic 30 in FIG. 2. The unique address 28, such as a MAC address, is required to obtain an IP address 48 and to be uniquely discovered and identified by, for example, the hub 14. Preferably, the device 12 should be able to automatically retrieve the IP address 48. This may be done via DHCP (Dynamic Host Configuration Protocol) or stateless auto-configuration. DHCP is an auto-configuration protocol used in IP networks. IPv6 does not require a DHCP server since IPv6 addresses can be uniquely generated internally using stateless auto-configuration. Stateless auto-configuration means that the least-significant part of the IPv6 address is based on the MAC address.

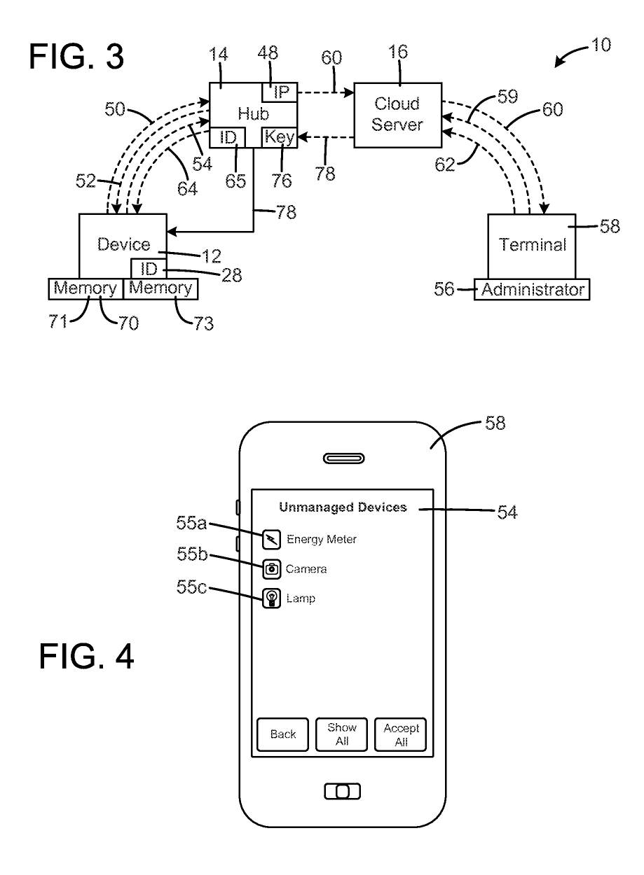

It is also important that the devices 12a-c are able to be discovered by the hub 14 either by sending an announcement signal 50 (best shown in FIG. 3) into system 10 in which the hub 14 is part of or by responding to a discovery request 52 from the hub 14, as shown in automatic discovery characteristic 34. The discovery request 52 may be sent by the hub 14 into the system 10 in order to try to discover new devices that are not managed by the hub 14 yet. It is thus important that the devices 12a-c are discoverable in the network of system 10. In this way, the device 12 may spontaneously announce its presence via the announcement signal 50 into system 10 or respond to discovery requests such as discovery request 52 from hub 14. This allows the device 12 to be automatically discovered by the system 10 i.e. by the hub 14. This may be implemented by using UPnP, mDNS or other similar schemes. The discovery message in the announcement signal 50 may contain information such as the unique address or ID 28 of the device 12, device type, communication method, management status (whether managed or unmanaged) and boot timer. A discovery response 54 from the device 12 in response to the discovery request 52 should at least include information about the unique address or ID 28 of the device 12 that received the discovery request 52 from the hub 14. By reporting the device type of the device 12, the hub 14 can launch the corresponding device driver to access this device 12. This may be a fixed value that is reported during discovery. In summary, the device 12 should be able to explain what it is and how it works so that a device driver may be automatically identified by the hub 14 to configure and use the device 12 correctly. Once the communication has been established between the device 12 and the hub 14, the hub 14 may register and characterize the device 12 as being unmanaged which means that the device 12 is not managed by the hub 14 yet.

New wireless devices will appear as unmanaged to all hubs within radio reach. A neighbor simultaneously looking for new devices as the administrator 56, may accept the newly discovered device before the rightful owner does. If the discovered device 12 is accepted by another hub, prior to hub 14, the device 12 must be reset. A device that has been reset will require the administrator 56 to show proof of physical access before allowing a hub to take charge. There may also be devices requiring physical access in the first time, such as high security devices. Physical access can, for example, be proven by knowing a code on a sticker placed on the device, by pressing a button on the device at a certain time, or using a terminal application to take a photo of the bar code on a sticker placed on the device.

In order for the hub 14 to be able to manage the device 12, the device 12 must be configured with communication parameters 40 based on information returned in, for example, the discover response 54, as shown in automatic communication configuration characteristic 42. This enables proper communication with the device 12.

As indicated in the automatic security configuration characteristic 44, the device should be able to be setup with encryption and authentication parameters based on, for example, information returned in the discovery response 54. It is also possible to use information in the announcement signal 50 if the first contact between the device 12 and the hub 14 was initiated by the device 12. Examples of suitable encryption procedures are described in more detail below.

According to the automatic device configuration characteristic 45, the device 12 must be able to be setup by, for example, the hub 14 with basic configuration parameters. The setup may be based on introspection or database lookup. Introspection may relate to the capability of the device 12 to respond to requests about its own capability such as ability to sense temperatures in Fahrenheit and/or Celsius between, for example, a temperature range of −40 C to +80 C. The device type information may be used by the hub 14 to determine the capabilities of the device 12 by looking up the device type in a database. The configuration parameters may, for example, be sample intervals, wake-up times to save on battery time, thresholds and alarm states. Combination of commands may also be used. For example, the device 12 may be set up to report the temperature every hour but if the temperature exceeds or goes below a certain temperature then the device 12 must immediately report this to the hub 14. This may be useful to prevent freezing when the temperature is too low. The report of a temperature that is too high may be important to report electrical faults or even fire. In this way, the wake-up time may be more frequent than the report signals that are sent to the hub. For example, the device 12 may be configured to measure the temperature every minute but only report the temperature to the hub 14 every hour unless the temperature is below or above a certain temperature when it sends the report signal right away to the hub 14.

Finally, the device 12 must be able to be subject to automatic management according to the automatic management characteristic 46. This step is done after all the configuration steps are completed. The automatic management 46 ensures that the device 12 is properly managed by the hub 14 and that the device 12 continues to work properly such as making sure the battery level is sufficient, that the software is properly updated and that information received from the device 12 is properly recorded and reviewed. More particularly, during the life-span of the device 12, the hub 14 may automatically monitor the device 12, log data from the device 12 and generally manage the device 12 with for example firmware upgrades.

An illustrative example of the provisioning steps is described in FIG. 3. In step 1, a user turns on the device 12. Depending upon the type of device, this may be done by inserting batteries into the device, plugging in the power cord or pressing an on/off switch. In step 2, the device 12 announces its presence on the network using the discovery mechanism such as sending the announcement signal 50 on a specific radio frequency or channel. If the device 12 receives no response on the specific radio channel within a certain time period such as 5 seconds, the device 12 may change radio channel and keep on trying different channels until it receives a response to the announcement signal 50 i.e. until the announcement signal 50 has been received by the hub 14 and the hub 14 has sent back a response signal to confirm receipt of the announcement signal 50. In other words, device 12 automatically sends the announcement signal 50 at a first frequency and the device 12 then waits for a response for a first time period, if no response is received within the first time period then the device 12 sends the announcement signal 50 at second frequency that is different from the first frequency. The device 12 may keep on sending announcement signals at different frequencies until the device receives a response from a nearby hub such as hub 14. It should be noted that several hubs may be found during this frequency scanning.

The device 12 may also respond to a discovery request 52 from the hub 14 as indicated above. In other words, the hub 14 may at certain time intervals send out discovery requests 52 to find out if there are any unmanaged devices in the system 10 that need to be managed. The hub 14 may send out the discovery requests at different frequencies or on different radio channels similar to the announcement signals 50 being on different radio frequencies. In this way, the hub 14 listens for discovery responses and announcements in order to discover the presence of a new device 12 in the system 10. If the device 12 is an unmanaged device, the hub 14, preferably, registers the new device and adds the device to a list 54 (best shown in FIG. 4) of such unmanaged devices 55a-c at all times. Upon receipt of the announcement signal 50, the hub 14 may determine whether the device 12 is managed or unmanaged by, for example, checking the announcement message. The hub 14 may send a request signal to the server 16 to request the server 16 to identify the device 12 by using the ID 28. It is important to note that the hub 14, preferably, does not send out any encryption keys to the device 12 at this point. Once the hub 14 has determined that device 12 is unmanaged, the hub 14 now waits for an acceptance signal (or a non-acceptance signal) from the administrator 56. Preferably, the hub 14 sends no configuration or provisioning signals to the device 12 until it has received an acceptance signal from the administrator 56. In step 3, the administrator 56 may log into the system 10 by using the terminal 58 and request to see unmanaged devices of the list 54. As indicated above, the administrator 56 may be the same person as the regular user 22 of the device 12 or a person different from the user. Step 3 is preferably done right after the new device 12 has been turned on and the initial communication between the device 12 and the hub 14 is complete. In step 4, the hub 14 displays the unmanaged devices 55a-c in the list 54 on the terminal 58 of the administrator 56 by sending a list or notification signal 60 to the terminal 58 via the server 16 to notify the administrator about the device 12 being among the unmanaged devices 55a-c and being characterized by the hub 14 as being unmanaged. The administrator 56 may also send a request signal 59 to the hub 14 prior to receiving the notification signal 60 to request to view the list 54 of unmanaged devices. In response to the request signal 59, the hub 14 may send the notification signal 60 to the terminal 58 of the administrator so that the administrator can view the list 54 of unmanaged devices. FIG. 4 shows an example of the list 54 of unmanaged devices 55a-c displayed on the terminal 58. The present invention is not limited to notifying the administrator 56 by sending the list 54 of unmanaged devices. The unmanaged devices 55a-c may be displayed in other ways than the list 54. In step 5, the administrator 56 may either accept the new device 12 or deny its acceptance. If the administrator 56 decides to accept the new device then the administrator may select an accept option by sending an accept signal 62 to the hub 14, directly or via the server 16, to indicate to the hub 14 that the newly discovered device 12 should be part of the system 10 and that the hub 14 should start the provisioning steps necessary so that the device 12 eventually may be characterized as being managed. As indicated above, as long as no accept signal 62 is received by the hub 14 or the administrator sends a non-acceptance or decline signal to the hub 14 then no further configuration signal is sent by the hub 14 to the device 12 and the provisioning procedure stops until such accept signal 62 is received by the hub 14. If it is assumed that the administrator sent the accept signal 62 to the hub then in step 6, the hub 14 initiates configuration communication parameters into the device 12 by sending a provisioning signal or a series of provisional signals 64, that, among other things, includes the unique ID 65 of the hub 14, to the device 12 to initiate configuration security parameters and configuration management parameters into the device 12 so the device 12 may be setup to communicate with the hub 14, as described in FIG. 3. By including the unique ID 65 of the hub 14 in the signal 64, the device 12 may communicate with the correct hub 14 and to prevent the device 12 from sending messages to another adjacent but incorrect hub, such as a hub of a neighbor that may be located in the vicinity. Finally, the hub 14 configures specific parameters of the device 12, if known. The hub 14 may now characterize the device 12 as being managed and the hub 14 will remove the device 12 from the list 54 of unmanaged devices 55a-c.

Devices 12a-c may be pre-provisioned so that other hubs, i.e. hubs other than hub 14, may never see them. This may, for example, be done at the time of the purchase of the device 12 where the credit card or store memberships card is tied with the ID of the purchased device.

The system 10 may use a variety of encryption schemes. Preferably, the device 12 may be required to support four keys i.e. vendor key, owner key, peer key and session key. Other suitable keys and encryption systems may also be used and the scheme described below is only an illustrative example. Vendor key 70 may be programmed into a non-volatile memory 71 (see FIG. 3) of the device 12 as part of manufacturing. The vendor key 70 is generally required for all devices 12 supporting encryptions. When the hub 14 receives the unique ID 28 of the device 12, the hub 14 may send a request signal to the server 16 that includes the ID 28 so that the server 16 can identify the vendor key 70 that matches the unique ID 28 of the device 12. The server 16 may respond by sending an encrypted message that requires the vendor key 70 to decrypt the message that the hub 14 may forward to the device 12 so that the device 12 may decrypt to gain access to the encrypted message from the server 16. The hub 14 may send a session key 76 to the server 16 so that the server 16 may include the session key 76 in an encrypted message 78 (see FIG. 3) that requires the vendor key 70 to be decrypted. In this way, the hub 14 may send the session key 76 to the device 12 in an encrypted format and when the encrypted message including the session key 76 is received by the hub 14 it may forward it to the device 12. Preferably the hub 14 cannot read or decrypt the message in the packet 78. Upon receipt, the device 12 may decrypt the packet 78 by using the vendor key 70 in order to gain access to the session key 76 so that the device 12 can communicate with encrypted messages with the hub 16 by using the session key 76.

The owner key may also be programmed into the non-volatile memory 71 of the device 12 when the device 12 is used, either as part of user delivery or by the user. The user needs to know the vendor key 70 for all its devices. The owner key is preferably optional. When the owner key is present, the vendor key 70 cannot be used for communication with the device 12. The peer key may also written into the non-volatile memory 71 of the device 12 when the device 12, for example, is peered to an account. The session key 76 is preferably set by the hub 14 when the device 12 is taken into the system 10. The session key 76 may be written to a volatile memory 73 and is therefore erased when the device 12 reboots.

There are situations when the device 12 and the hub 14 may require that the user must prove physical access to the device 12 before the device can be accepted such as when the device 12 requires physical access verification from the owner. The owner may provide the owner key to clear the owner. Preferably, high security devices should require this. Also, when a user turns on a wireless device 12 and another adjacent system similar to system 10 is quicker to accept the new unmanaged device 12 the device will belong to the other adjacent system. This could not happen if the device is pre-provisioned as described above. The owner may then, for example, click a reset button on the device 12 and/or provide the owner key to make the device 12 available to the system 10. The next time the hub 14 discovers the device 12, the administrator 56 may also be required to provide physical access to the device 12 before the administrator 56 can be accepted into system 10. Physical access may, for example, be proven by knowing a code on a sticker placed on the device 12, by pressing a button on the device 12 at a certain time or using a terminal application to take a photo of a bar code on a sticker placed on the device 12.

There are many ways to distribute keys to the device. As indicated above, new unique encryption keys can be distributed to a new device 12 by pre-configured symmetrical keys in the device 12 that are known in the server 16 when the server 16 is considered secure. A Diffie-Hellman key exchange may also be used so that the hub 14 and the device 12 may exchange encryption keys with one another to set the session key. Unencrypted key distribution over a secure medium (usually wired) and other suitable key exchange methods may also be used.

While the present invention has been described in accordance with preferred compositions and embodiments, it is to be understood that certain substitutions and alterations may be made thereto without departing from the spirit and scope of the following claims.

We claim:

1. A method for automatic provisioning of a device, comprising,
providing a system having a device, a hub, a server and a communication device,
establishing a communication between the device and the hub,
the hub characterizing the device as being unmanaged,
the hub sending a notification signal to the terminal of an administrator to notify the administrator about the device being characterized as unmanaged,
in response to the notification signal the administrator sending an accept signal to the hub to accept the device as being part of the system,
upon receipt of the accept signal, the hub sending a provisioning signal to the device to provision the device and characterizing the device as being managed, and
the hub delaying sending the provisioning signal to the device as long as no accept signal is being received from the administrator.

2. The method of claim 1 further comprising the steps of the device sending an announcement signal to the hub.

3. The method of claim 1 further comprising the steps of the hub sending a discovery request into the system to discover unmanaged devices.

4. The method of claim 2 further comprising the steps of including a unique address ID of the device in the announcement signal.

5. The method of claim 1 further comprising the steps of the hub sending configuration parameters to the device based on introspection or database lookup.

6. The method of claim 1 further comprising the steps of the device automatically sending an announcement signal at a first frequency, the device waiting for a response a first time period, when no response is received within the first time period, the device sending the announcement signal at a second frequency that is different from the first frequency.

7. The method of claim 2 further comprising the steps of the hub receiving the announcement signal and registering the device on a list of unmanaged devices.

8. The method of claim 7 further comprising the steps of the administrator sending a request signal to the hub to view the list of unmanaged devices.

9. The method of claim 1 further comprising the steps of including a hub ID in the provisioning signal.

10. The method of claim 1 further comprising the steps of the hub sending a request signal to the server to request the server to identify the device based on the ID and the announcement signal.
